(19) United States
(12) Patent Application Publication
(10) Pub. No.: US 2006/0125826 A1
(43) Pub. Date: Jun. 15, 2006

(54) Method and system for mass spectrometry and gas chromatographic data analysis

(76) Inventors: Joaquin A. Lubkowitz, Gulf Breeze, FL (US); Roberto I. Meneghini, Gulf Breeze, FL (US)

Correspondence Address: ARENT FOX PLLC, 1050 CONNECTICUT AVENUE, N.W., SUITE 400, WASHINGTON, DC, 20036, US

(21) Appl. No.: 11/009,580

(22) Filed: Dec. 10, 2004

(51) Int. Cl. G06T 11/20

(52) U.S. Cl. 345/440

(57) ABSTRACT

Systems and methods for correlating and displaying the data produced by GC and MS. The data are correlated by representing MS data in the time domain, and GC and MS data are simultaneously displayed. When a particular mass spectrum is extracted, a search engine searches libraries for components with matching mass spectra. Further features provide for manipulation of the display, extraction of ion signals, subtraction of spectra from the display, removal of ions from the display, performing ion interference analysis, filtering the displayed data based on various criteria, transferring MS data to an active parameter data file, and transferring MS data to libraries.

### BACKGROUND OF THE INVENTION

1. Field of the Invention

The present invention relates to a method and system for correlating and managing the data produced by gas chromatography (GC) and detectors such as the mass spectrometry (MS).

2. Background of the Technology

Gas chromatography (GC) is a widely used analytical technology that is finding a growing number of applications in the analysis of volatile and semi-volatile compounds. In conventional GC processes, a sample is vaporized and the entire resulting quantity of gases is passed through an analytical chromatography column. The compounds are analyzed by a detector as they exit the column.

Among the currently available GC detectors, the flame ionization detector (FID) is most widely used and for the broadest range of applications. The FID is based on the combustion of organic compounds that elute from the GC column in a hydrogen diffusion air flame and the consequent production of charged species from the combustion of the organic compounds. The FID is a highly successful detector due to its robustness, high reliability, high sensitivity, universal carbon-selective detection capability, broad linear dynamic range, fast response, high temperature operation capability and excellent reproducibility. As a result, the FID has become the GC industry's standard detector of choice.

In mass spectrometry (MS), a compound is bombarded with an electron beam having sufficient energy to fragment the molecule. A combination of electric and magnetic fields accelerate the ions produced in a vacuum towards various detectors. Ions travel at different speeds through the mass spectrometer depending on their mass and charge. Heavier particles travel more sluggishly for shorter distances than lighter particles under the influence of the fields in the mass spectrometer. The ions are sorted on the basis of mass-to-charge ratio (m/z), and measuring the time it takes the ions to travel a predetermined distance provides a relative indication of their weight. The detector produces an m/z value along with a relative measure of intensity. The analysis of mass spectroscopy information involves the re-assembling of fragments, working backwards to generate the original molecule.

Computer-assisted analyses use MS data to identify and classify the makeup of a sample. Classification involves searching through a library or table of isotopic masses and identifying the constituent elements. An isotopic or monoisotopic mass is calculated using the mass of the most abundant natural isotope of each constituent element. In comparison, an average mass is calculated using the “atomic weight” of each constituent element, which is the weighted average of all its natural isotopes.

These two techniques can be combined in gas-chromatography mass-spectrometry (GC/MS). In machines using the GC/MS technique, the injected sample first passes through a GC column, which separates the individual components from the sample gas mixture. As the individual components exit the GC column, they enter the MS chamber, where they are chemically analyzed.

A major problem with using GC, MS, or GC/MS techniques is that it is difficult to correlate the data from one technique (e.g., GC/Detector) with the data from another (e.g., GC/MS). This is particularly true if the analysis involves large number of compounds. A major problem in using GC/MS for quantitation when samples have large numbers of compounds is maintaining the complete signal in a linear range to obtain mass spectrometry response factors. Therefore, it would be of great advantage to operate GC in such a way that a fraction of the signal enters the MS and the remaining fraction enters the FID detector. The problem encountered with this arrangement is that software programs of GC data acquisition must operate simultaneously with the Detector, e.g. FID. This forces the user to continuously flip between the MS Software and the GC/D software. This forces the user to operate in a mode of continuously flipping between the two software in order to transfer the MS identified peaks to the FID “peak table”. Furthermore, in other types of analysis, i.e. gasoline, additional software programs are required to analyze the gasoline sample which have 400+ components. This other software is called Detailed Hydrocarbon Analysis Software (DHA). This software is used with a GC/FID only, leaving fundamentally the identifity factor to the MS.

There is therefore a need for a method and system for correlating and managing the data produced by GC and MS.

### SUMMARY OF THE INVENTION

One aspect of the present invention relates to systems and methods for correlating the data produced by GC and MS. One implementation simultaneously presents the user with correlated GC data and MS data. The user may select a particular mass spectrum and search various libraries for components with matching mass spectra. The names and mass spectra of the matching components are displayed to the user.

One aspect of the present invention provides a method for displaying data to a user. Gas chromatography data, including at least one elution peak, are received, for example, from a gas chromatography detector, and mass spectrometry data including at least one mass spectrum are received, for example, from a mass spectrometer. The gas chromatography data and the mass spectrometry data are correlated, for example, by representing the mass spectrometry data in the time domain and by correlating each mass spectrum with an elution peak. The gas chromatography data and the mass spectrometry data are simultaneously displayed to a user.

The user may select one or more libraries, each library containing one or more components, and each component having at least one mass spectrum. The user may then select, or extract, one mass spectrum from the displayed mass spectrometry data. The selected libraries are searched for components with mass spectra matching the extracted mass spectrum. The names and mass spectra of the matching components are displayed to the user.

Further features of the invention allow the user to manipulate the display, extract ion signals, subtract spectra from the display, remove ions from the display, perform ion interference analysis, filter the displayed data based on various criteria, transfer MS data to an active parameter data file, and transfer MS data to libraries. Additionally, the identification of the GC/MS is transferred to the FID/DHA or similar combination of software identification file where automatically all properties pertaining to the identified compounds are transferred.

One implementation of the present invention includes software that incorporates the GC/FID function that is used jointly with the DHA software with the GC/MS software into one single application software. The advantages are as follows.
1. both the FID signal integration results are available on the same screen as the MS-Signal. Thus algorithms have been designed that transfer the GC/MS identification to the FID component table instantly.
2. This new software incorporating all the features, i.e. GC/FID/DHA/MS, now liberates the user from requiring calibrating with the MS.
3. The continuous switching between software is not necessary since all of the signals are displayed simultaneously on the screen.

This is because the GC data (chromatogram) is generated and plotted as elution time on the X-axis to peak height (concentration) on the Y-axis, while the MS data are generated and plotted as m/z on the X-axis to ion abundance (intensity) on the Y-axis. It is difficult to match up a particular elution peak from the GC with its corresponding MS data.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

FIG. 1 is a flow chart illustrating a method for presenting a user with data, in accordance with an embodiment of the present invention;

FIG. 2A is a block diagram of system components, in accordance with an embodiment of the present invention;

FIG. 2B presents an exemplary system diagram of various hardware components and other features, in accordance with an embodiment of the present invention;

FIG. 3 is a pictogram of various system components, in accordance with an embodiment of the present invention; and

FIGS. 4-38 are Graphical User Interface (GUI) screens that are presented to a user, in accordance with an embodiment of the present invention.

### DETAILED DESCRIPTION

One advantage of the present invention is its ability to receive and process GS and MS data from any instrument in any format. In one implementation, the GC data come from a stand-alone GC machine and the MS data are obtained from a separate stand-alone MS machine. In another implementation, the GC and MS data come from the same machine (e.g., a GC/MS). In yet another implementation, one of the GC data or the MS data comes from an appropriate existing library or some other source, while the other is generated. Finally, it is within the scope of this invention that both the GC and MS data come from appropriate existing libraries or other previously-generated sources.

One aspect of the present invention provides systems and methods for analyzing and identifying petroleum components. Petroleum compounds, such as compounds produced in a pilot plant, a reformulated gasoline (RFG) unit, a fluid catalytic cracker (FCC) unit, a hydrocracker unit, an atmospheric distillation tower, a vacuum distillation tower, or a sulfur recovery unit (SRU), are provided, for example, to a GC/MS machine, which generates the GC data and the MS data.

The present invention receives both GC and MS data, and correlates the data. The data are then presented to a user in a way that allows the user to observe the relationship between the GC and MS data. In one implementation, the output from the mass spectrometer can be correlated with the elution peaks from the gas chromatography detector. In practice, this may be accomplished by representing the mass spectrometry data in the time domain. A mass spectrum located at a particular time is correlated with the elution peak at that particular time.

In one implementation, the present invention is incorporated with a GC analysis system, such as the Hydrocarbon Expert (HCE) system, manufactured by Separation Systems, Inc., of Gulf Breeze, Fla. In this case, systems and methods for analyzing GC data from the GC analysis system may be used in conjunction with the systems and methods of the present invention.

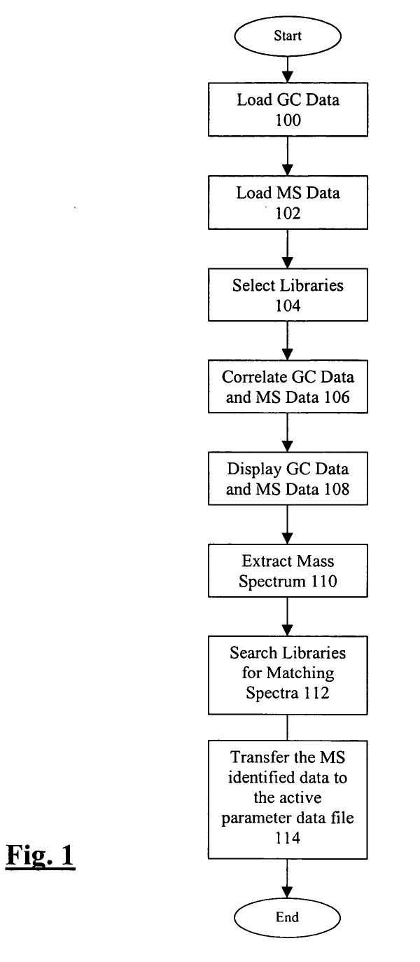

FIG. 1 is a flow chart illustrating a method for presenting a user with data, in accordance with an embodiment of the present invention.

The method begins, for example, in step 100, wherein GC data are loaded. In one implementation, the present invention is integrated with the HCE system, and the GC data are loaded into the HCE system. The GC data may be received from a stand-alone GC machine, a GC/MS machine, or an appropriate existing library or some other source. The GC data include one or more elution peaks, which correspond to one or more components to be identified or otherwise analyzed.

In step 102, MS data are loaded. The MS data are received, for example, from a stand-alone MS machine or a GC/MS machine, or an appropriate existing library or some other source. The MS data contain one or more spectra, which correspond to one or more components to be identified or otherwise analyzed.

In step 104, one or more libraries may be selected. Each of the libraries contains data for one or more components. The data for each component comprise, for example, a component name, a mass spectrum, and other associated data. The libraries are used in the identification or analysis of the GC or MS data. The mass spectra from the received MS data may be compared to the mass spectra in the libraries.

In one implementation, the libraries may be automatically or electronically selected. In another implementation, user selection of the libraries may be optional. In still another implementation, library selection functionality may not be provided.

In one implementation of the present invention, one or more libraries may be provided. However, users may also import libraries from other sources or may create libraries. The user selects one or more libraries based on the type of analysis required. For example, the user may only be interested in petroleum components, and may therefore select a library containing only those components.

In step 106, GC data and MS data are correlated. This includes, for example, representing the MS data in the time domain, such that the mass spectrum for a particular component corresponds to the elution time for that component. If the GC data and MS data are received from a GC/MS machine, the GC data and the MS data may both be provided in the time domain, and the additional correlation in step 106 may be unnecessary.

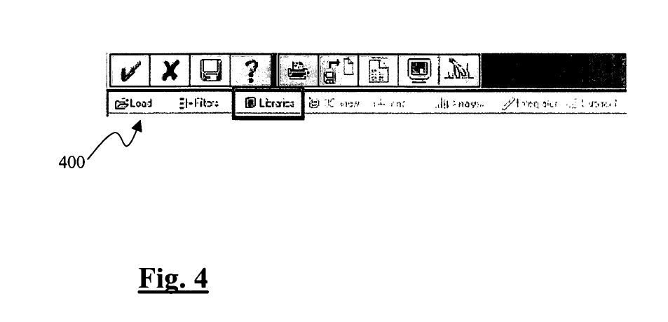

In step 108, GC data and MS data are displayed, for example, to a user. The GC data and MS data are both displayed, for example, in the time domain. The GC data may be displayed in a first panel as a GC display, and the MS data may be displayed in a second panel as an MS display. Various features of the present invention allow for the manipulation of the display to analyze the GC and MS data. For example, features of the present invention allow users to manipulate the display, extract ion signals, subtract spectra from the display, remove ions from the display, perform ion interference analysis, filter the displayed data based on various criteria, transfer MS data to an active parameter data file, and transfer MS data to libraries. These features of the invention will be discussed further below with reference to FIGS. 4-38.

In step 110, a mass spectrum may be extracted. Extracting a mass spectrum includes, for example, receiving a user input specifying a mass spectrum from the MS data for further analysis. In one implementation, the user selects a mass spectrum from the MS display.

In step 112, a matching engine searches the selected libraries. The matching engine receives the selected or extracted mass spectrum, and searches the selected libraries for components with similar mass spectra. In one implementation, the matching engine identifies as matches only those components with a match number and/or probability number in a predetermined range.

The matching spectra are displayed, for example, to a user. The extracted spectrum may also be displayed. In one implementation, the extracted spectrum is displayed on a separate panel below the MS display. The extracted spectrum is shown with the best matching spectrum from the selected libraries, as identified by the search engine. The names of all the matching components identified by the matching engine are listed, for example, in a scrolling box. The user may select a component name from the scrolling box to compare that component against the extracted spectrum.

The extracted spectrum is, for example, the spectrum of an unknown component. Based on the results of the search, the unknown component is determined to be one of the components identified by the search engine. In one implementation, the user reviews the extracted spectrum and the matching spectra and determines the identity of the unknown component. In another implementation, the unknown component is identified electronically, for example, by the search engine. Once the unknown component has been identified, the MS data for the component is transferred to an active parameter data file in step 114.

The active parameter data file, also known as the HCD or the GC/FID data table, is the file being used in the identification of the sample being analyzed. For example, data identifying the various components in the sample are kept in this file. The data in the active parameter data file includes, for example, both GC data and MS data. In order to transfer MS data from the library to the active parameter data file, the user selects a name for the component, and the MS data for the component is transferred. In another implementation, it is the extracted mass spectrum or other data from the MS data file that is transferred to the active parameter data file.

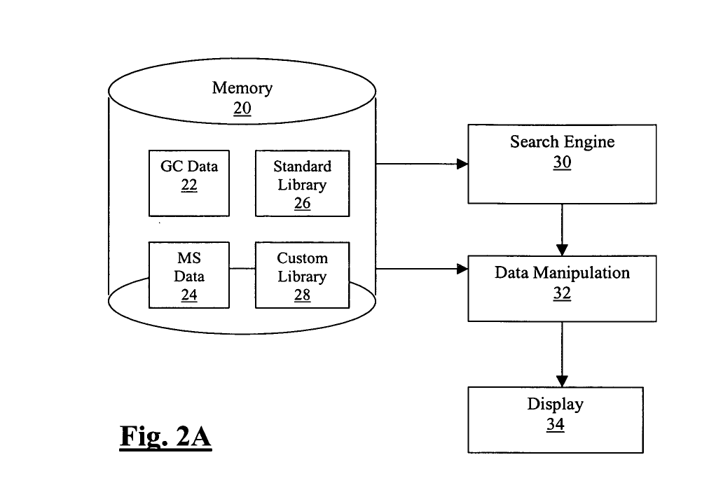

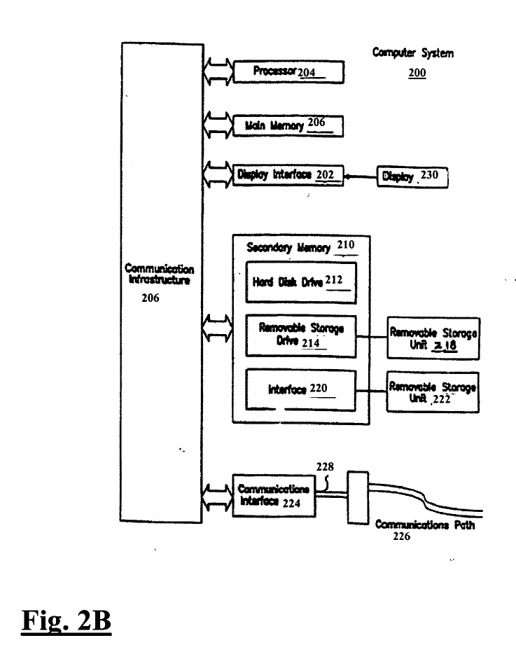

FIG. 2A is a block diagram in accordance with an embodiment of the present invention. As shown in FIG. 2A, the invention may include a memory 20, such as a database or other electronic storage element. The memory 20 includes, for example, GC data 22 and MS data 24, which are, for example, experimental data uploaded by a user from a GC/MS machine or other appropriate source. The memory 20 may also includes one or more standard libraries 26, which are, for example, libraries that are initially incorporated in the present invention. The memory 20 may also include one or more custom libraries 28, which are, for example, libraries the user creates or uploads from an appropriate source. Each of the libraries 26, 28 contains data for one or more components. The data for each component comprises, for example, a component name, a mass spectrum, and other associated data.

In one implementation, the invention also includes a search engine 30, which receives a selection of libraries and an extracted mass spectrum. The selection of libraries and the extracted mass spectrum are, for example, selections made by a user. The selected libraries comprise, for example, one or more of the libraries 26, 28; and the extracted mass spectrum comprises, for example, one mass spectrum from the MS data 24. The search engine 30 searches the selected libraries for components with mass spectra matching, or similar to, the extracted mass spectrum.

In one implementation, the invention includes a data manipulation module 32. The data manipulation module 32 receives data from the memory 20 and from the search engine 30, and performs any necessary operation on the data before it is displayed. This includes, for example, filtering data before it is displayed to the user, subtracting one spectrum from another at the request of a user, subtracting one or more ions, and the like. These operations are described in further detail below with reference to FIGS. 4-38.

In one implementation, the invention includes a display module 34. The display module receives data, for example, from the data manipulation module 32. The display module displays the data to a user, and allows performance of any necessary data display operations, such as zooming, shifting, scrolling, and the like. The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 2B.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

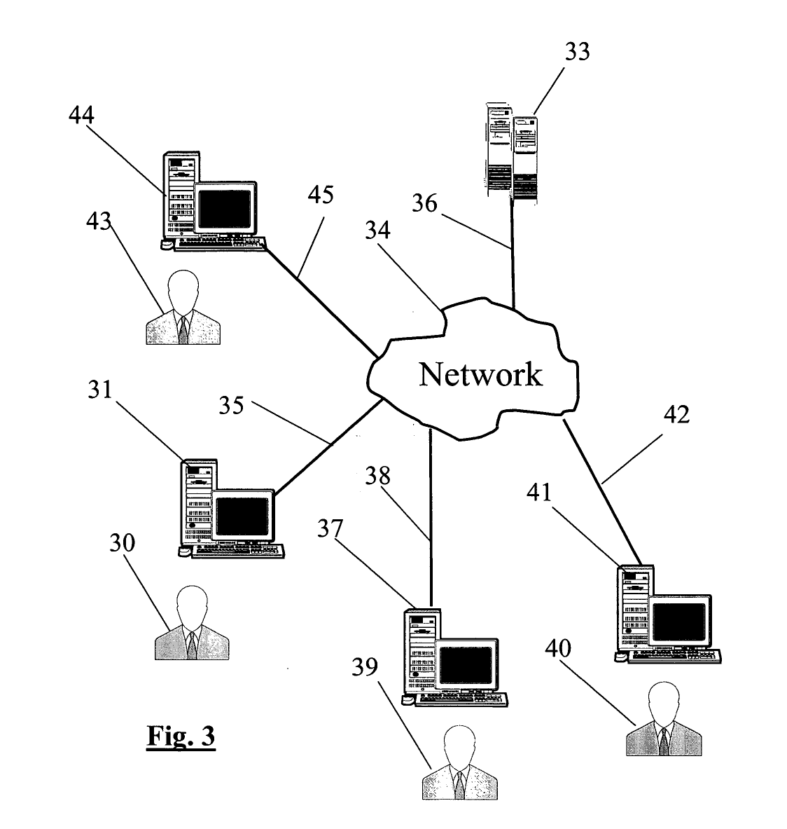

FIG. 3 presents an exemplary system diagram of various hardware components and other features in accordance with an embodiment of the present invention for use via a network. As shown in FIG. 3, in an embodiment of the present invention, data and other information and services for use in the system is, for example, input by an end user 30 via a terminal 31. The terminal 31 is coupled to a server 33 via a network 34, such as the Internet, via couplings 35, 36. In one embodiment, a remote user 39 also inputs information/data via a terminal 37 coupled 38 to the network 34. Furthermore in one embodiment, a GC technician 40 inputs information/data via a terminal 41 coupled 42 to the network 34, and in another embodiment, an MS technician 43 inputs information/data via a terminal 44 coupled 45 to the network 34.

Each of the terminals 31, 37, 41, 44 is, for example, a personal computer (PC), minicomputer, mainframe computer, microcomputer, telephone device, personal digital assistant (PDA), or other device having a processor and input capability, and optionally coupling to a device, or incorporated into a device for providing sampling data, such as a machine using GC/MS. The terminal 31 is coupled to a server 33, such as a PC, minicomputer, mainframe computer, microcomputer, or other device having a processor and a repository for data or connection to a repository for maintained data,

In operation, in an embodiment of the present invention, via the network 34, GC data, MS data, library data, user selections, and/or other information is communicated with the server 33. The server 33 receives the information and performs operations, including storing data, performing searches for matching mass spectra, and performing data manipulation. However, in one implementation, the server 33 is incorporated in one or more of the terminals 31, 37, 41, 44.

FIG. 4 is a GUI screen that is presented to a user, in accordance with an embodiment of the present invention. A user may log into a system, for example, by providing a user name and password. Once the user has logged into the system, one or more GUI screens are presented. In one implementation, each of the GUI screens includes a toolbar 400, as shown in FIG. 4.

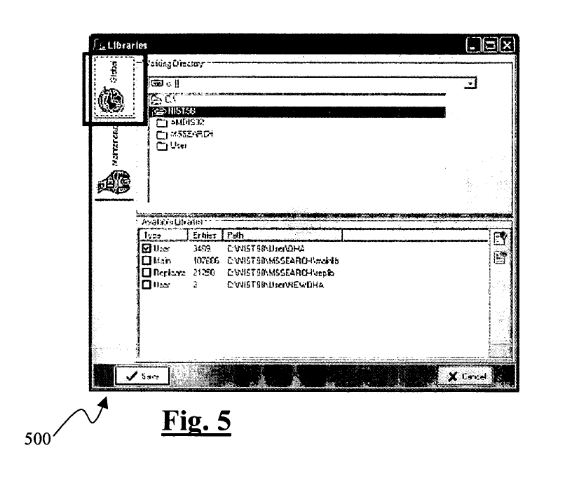

In one embodiment of the present invention, the user selects a working directory prior to loading data. The working directory is, for example, a directory that the search engine uses to store temporary files needed for spectral matching. In order to select a working directory, the user selects “Library” from the toolbar 400. The user is then presented with the GUI screen 500 of FIG. 5. The user selects “Global” and then specifies the path to the desired working directory.

In one embodiment of the present invention, one or more spectral libraries are used. Libraries are databases of spectra that the search engine uses for spectral matching. In some implementations, one or more spectral libraries may be provided to the user. In other implementations, the user may wish to add one or more spectral libraries that are specific to the user's needs.

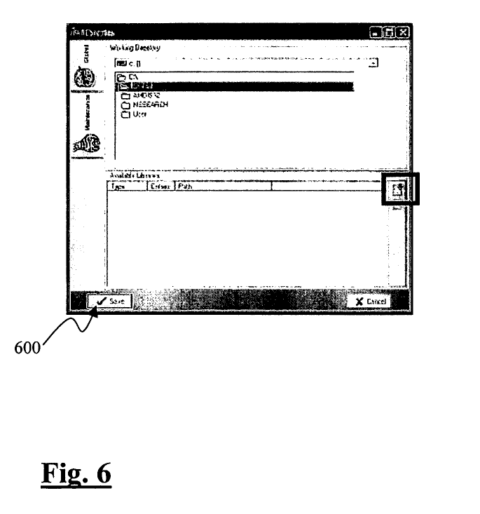

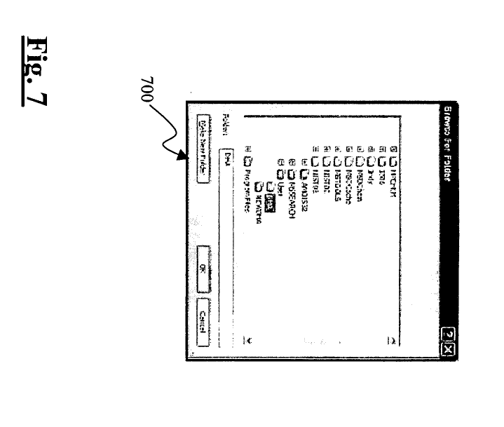

To access library management features, the user selects “Library” from the toolbar 400, and then selects “Global” from the GUI screen 500 of FIG. 5. To add a library, the user then selects the plus sign from the GUI screen 600 of FIG. 6. The user is presented with the GUI screen 700 of FIG. 7, and selects the directory containing the library to be added.

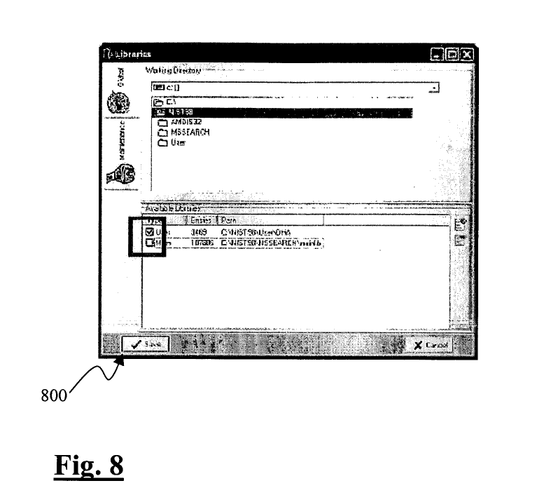

The user may select one or more libraries to be used in spectral matching. In the GUI screen 800 of FIG. 8, the user checks the library or libraries to be used.

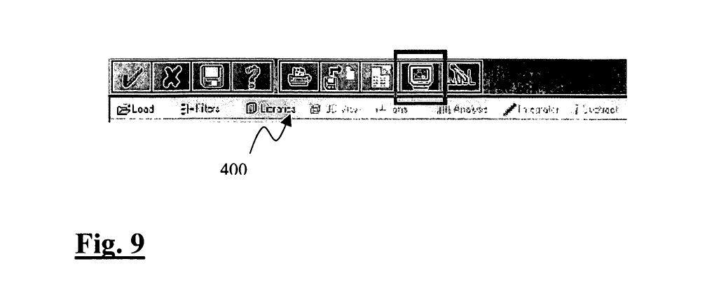

In one embodiment, the present invention is integrated with another application, such as, for example, the HCE system. In this implementation, as shown in FIG. 9, the MS analysis feature of the present invention can be turned on or off by selecting the MS button from the toolbar 400.

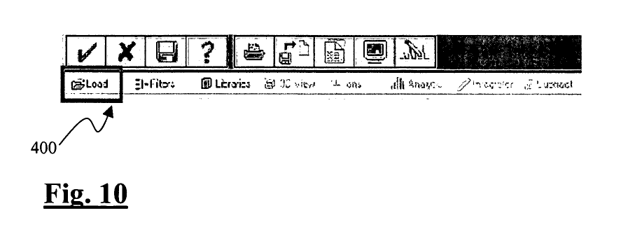

As shown in FIG. 10, to load an MS data file, the user selects “Load” from the toolbar 400, and then selects the desired MS data file. In one implementation of the present invention, the MS analysis features of the present invention are integrated with another application, such as, for example, the HCE system. In this case, the user has, for example, previously loaded and selected GC data. The MS data file loaded by the user is correlated with the selected GC data. For example, each elution peak in the GC data is correlated with a particular spectrum in the MS data file.

The MS data file is displayed, for example, as an MS display, and the GC data is displayed as a GC display. The MS display is located, for example, above the GC display and in a separate window. In one implementation, the MS display uses the time scale settings of the GC display. Scale changes made to the GC display are reflected in the MS display. However, the MS display can be moved and zoomed independently or synchronized from the GC display and vice versa. The splitting of the column effluent is arranged such that there is no time lag between signals.

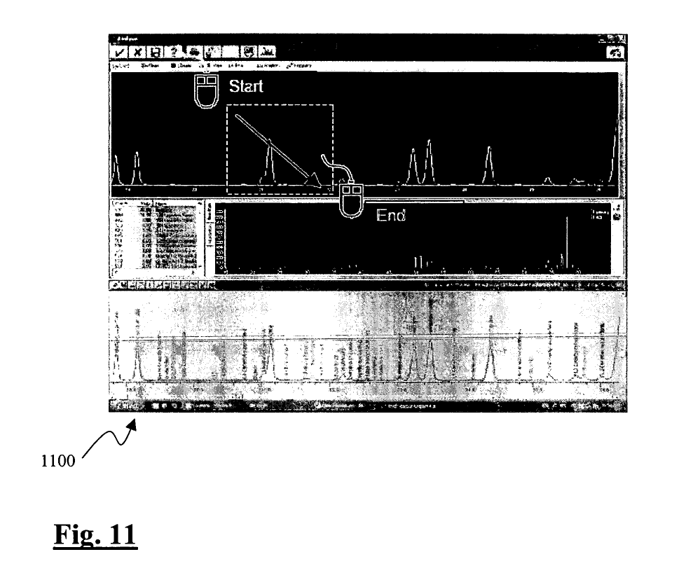

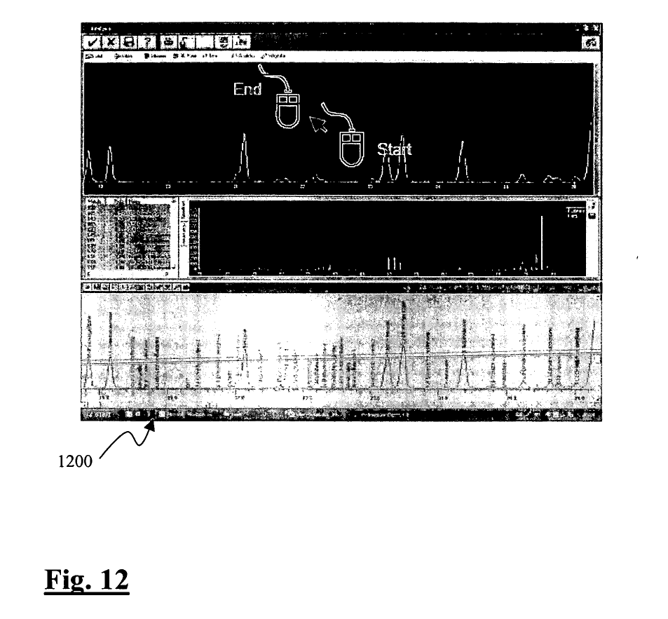

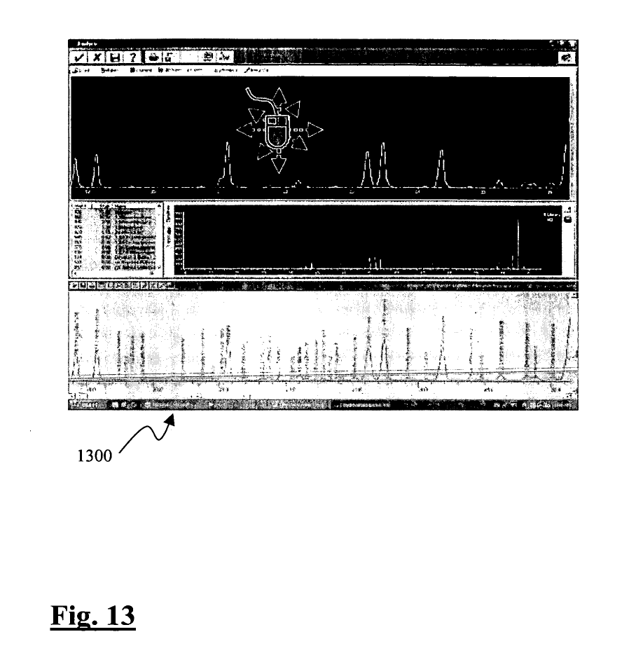

As shown in FIG. 11, to zoom in a section of the MS display, the user may, for example, click and drag the mouse from the upper left corner to the bottom right corner using the left button of a mouse, or use another similar selection technique. As shown in FIG. 12, to restore the original scale of the MS display, the user may, for example, click and drag the mouse from the bottom right corner to upper left corner using the left button of the mouse. As shown in FIG. 13, the MS display can be similarly scrolled in any direction by moving the mouse while holding down the left button of the mouse.

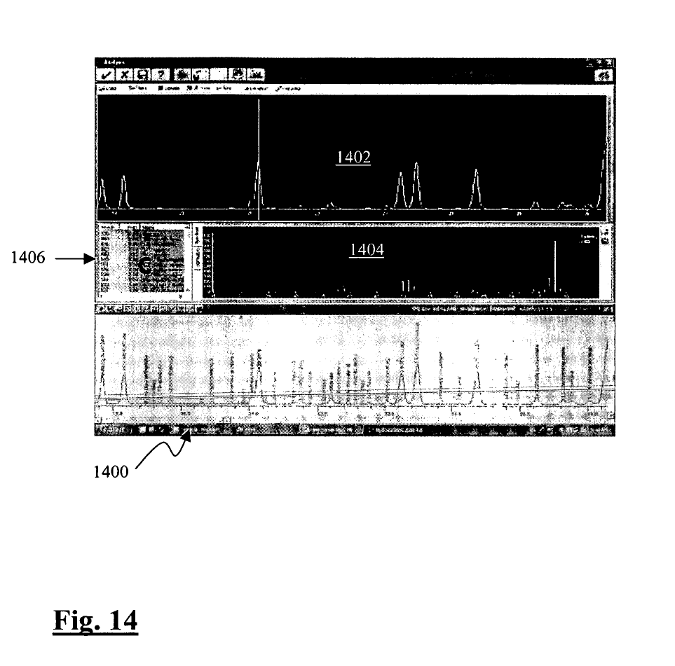

In one embodiment of the present invention, one spectrum from the MS display can be extracted, or isolated, for further study. To extract a mass spectrum, the user selects a desired point in time of the MS display, such as, for example, by double-clicking in the MS display. The selected point in time is highlighted, for example, by a vertical dotted line, as shown in panel 1402 of FIG. 14.

When a mass spectrum is extracted, the search engine searches the selected libraries for mass spectra matching the extracted mass spectra. The search now brings up data for the total ion chromatogram and also the molecular spectra as well as the GC/D (e.g. FID) chromatogram all in one screen or GUI.

The extracted spectrum is displayed, for example, on a separate panel 1404 just below the MS display. The extracted spectrum is shown with the best matching spectrum from the selected libraries, as identified by the search engine. The masses of the extracted spectrum are displayed, for example, in red, while the masses of the library spectrum are shown in green. In cases such as using MS/DHA, there are five different groups of components that we work with and each group of component is given a different color code in order to visually aid the user in the visual identification of each group or subgroup of components.

The matching components from the selected libraries are listed, for example, in a scrolling box 1406. A user may select a component name to compare the extracted spectrum against the library spectrum of the selected component.

In one implementation, the present invention provides a tool and icon to visualize extracted ion signals. This tool is used, for example, to not only to identify co-eluting components but also to visually identify them on the GUI or screen.

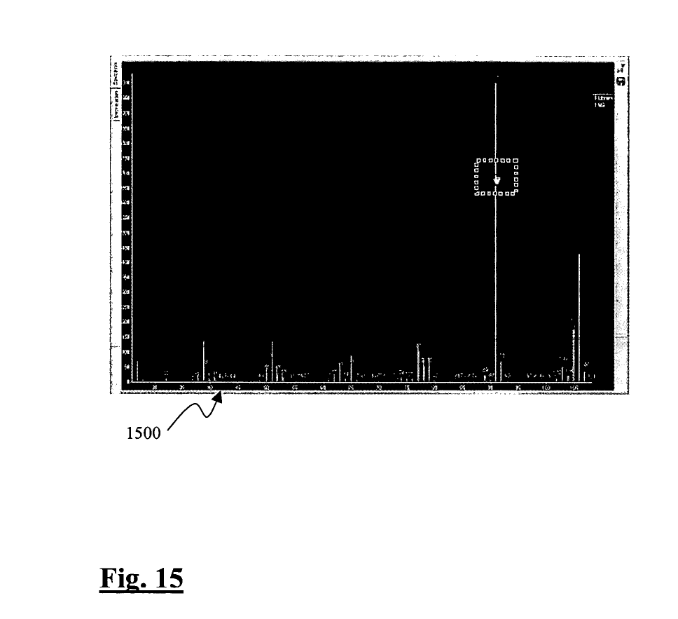

The user can access extracted ion signals, for example, from the extracted spectrum display panel 1404. The user selects a bar in the extracted spectrum to show or hide the extracted ion. In one implementation, when the cursor is placed on a bar of the extracted spectrum plot, the cursor will change to a “pointing hand” icon, as shown in FIG. 15. Depressing the left button of the mouse in the “pointing hand” mode will cause the corresponding extracted ion to be shown. If the extracted ion signal is already visible, then it will be hidden.

The user can display extracted ion signals, for example, from the extracted spectrum display panel 1404. The user selects a bar in the extracted spectrum to show or hide the extracted ion. In one implementation, when the cursor is placed on a bar of the extracted spectrum plot, the cursor will change to a “pointing hand” icon, as shown in FIG. 15. Depressing the left button of the mouse in the “pointing hand” mode will cause the corresponding extracted ion to be shown. If the extracted ion signal is already visible, then it will be hidden.

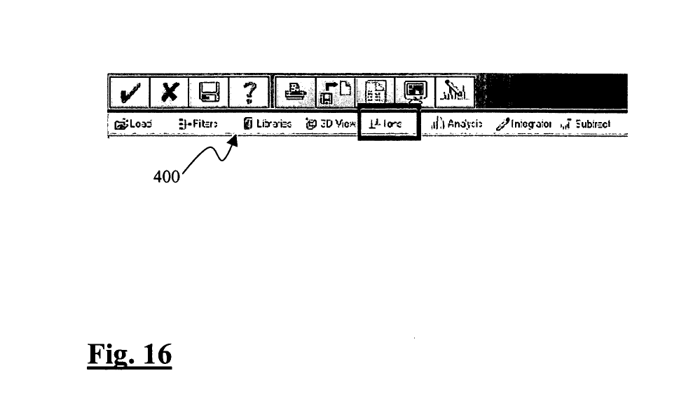

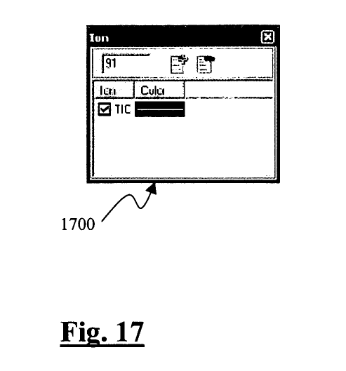

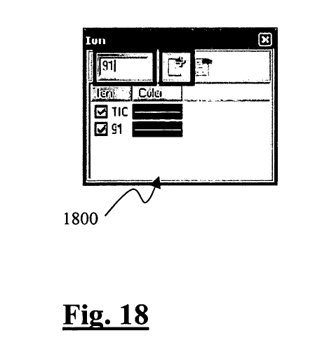

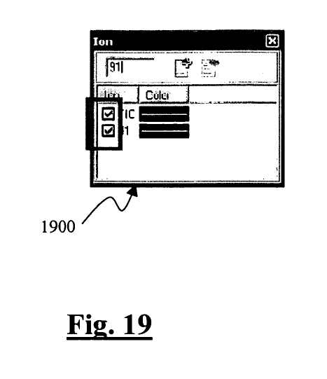

The user may also choose to display extracted ion signals using an ions dialog. As shown in FIG. 16, the user accesses the ions dialog by selecting the “Ions” button from the toolbar 400. As shown in FIG. 17, the ions dialog can be used to add, remove, show, hide and change color of extracted ion signals. As shown in FIG. 18, to add an extracted ion, the user enters the desired mass value and then selects the plus button. As shown in FIG. 19, the user selects a check mark in the box to the left of the listed mass to display the extracted ion signal. Likewise, removing the check mark hides the extracted ion signal.

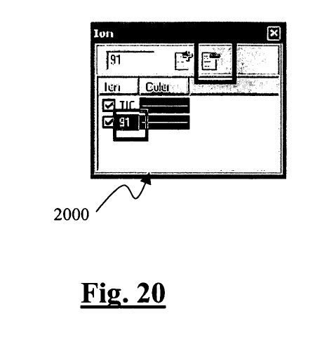

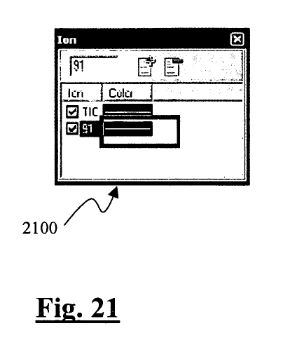

As shown in FIG. 20, to remove an extracted ion signal from memory, the user selects the desired listed mass and then selects the “minus” button. As shown in FIG. 21, to change the color of an extracted ion signal, the user selects the color field of the desired ion and selects the new color from the palette displayed.

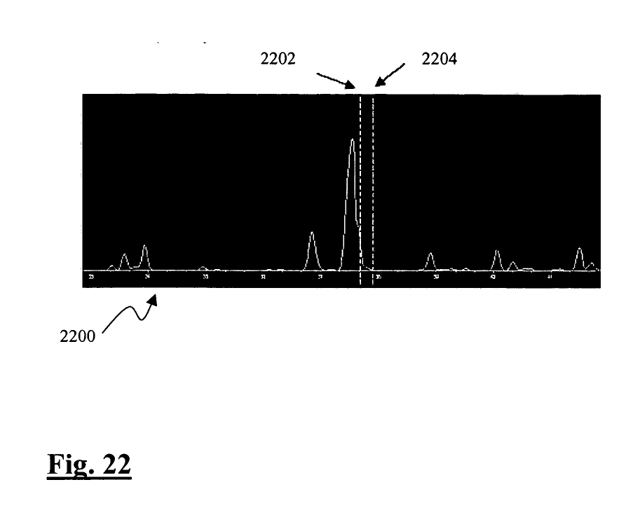

In performing analyses of MS and GC data, the user may wish to subtract or remove one or more spectra from the MS display. This is useful, for example, in the case where two or more spectra overlap, or when one spectrum is interfering with the analysis of another spectrum. As shown in FIG. 22, the user first selects the scan point 2202 identifying a first spectrum or scan A. The user then selects the scan point 2204 identifying a first spectrum or scan B, which is the spectrum to be subtracted.

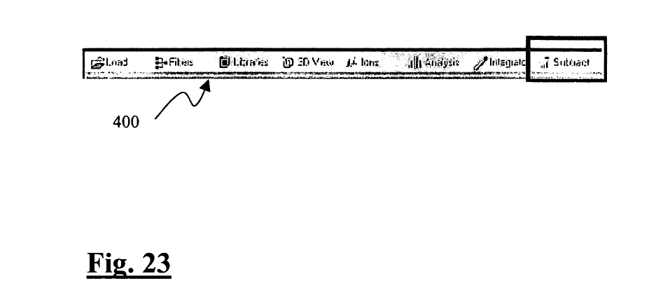

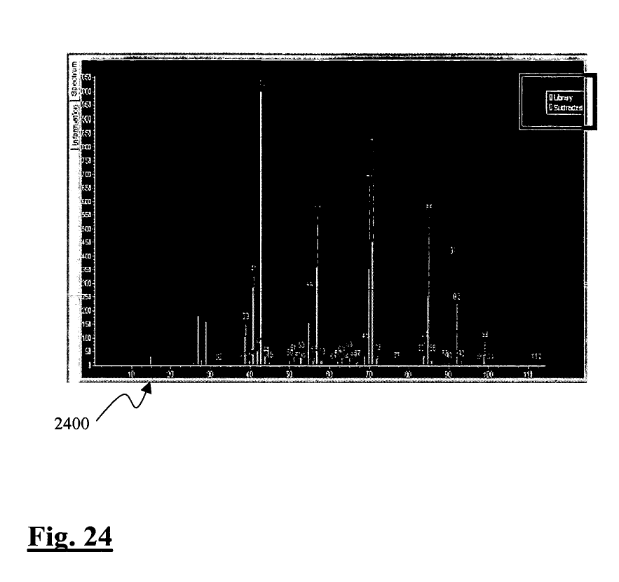

As shown in FIG. 23, the user selects the “Subtract” button from the toolbar 400. Spectrum B will be subtracted from spectrum A and the resulting spectrum (A-B) will be displayed and identified. As shown in FIG. 24, the new spectrum is labeled “Subtracted.”

In addition to subtracting one spectrum from another, the subtraction feature can also be used to subtract a part of a spectrum from the whole of that spectrum. This is useful, for example, if a part of the spectrum is particularly crowded and the user wishes to look at one fragment of the compound.

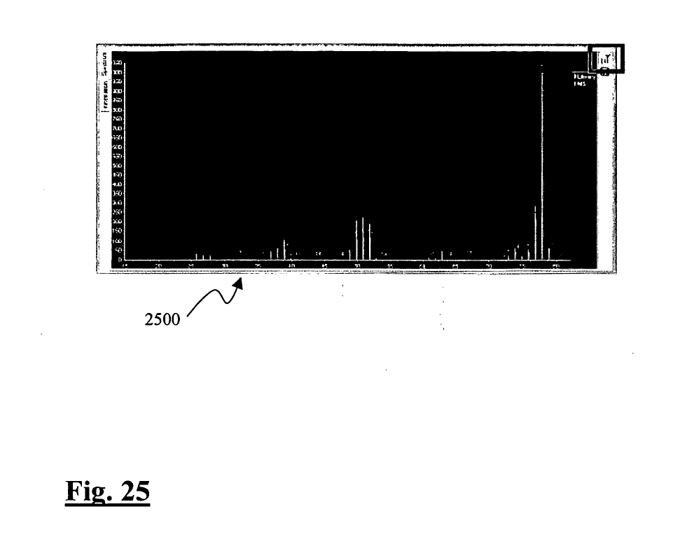

In performing analyses of MS and GC data, the user may wish to remove one or more ions from the MS display. As shown in FIG. 25, the user selects the “Remove Ion” button. The user then selects the ion to be removed. The user selects the ion, for example, by placing the cursor on top of the ion bar. The cursor will change to a “pointing hand” icon, and the user clicks to select the ion bar. The ion will be removed and the spectrum will be renormalized and identified. This process may be repeated to remove other ions.

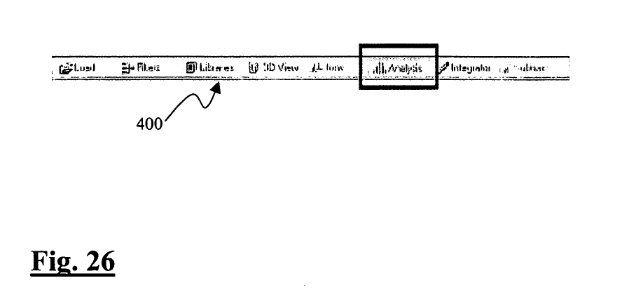

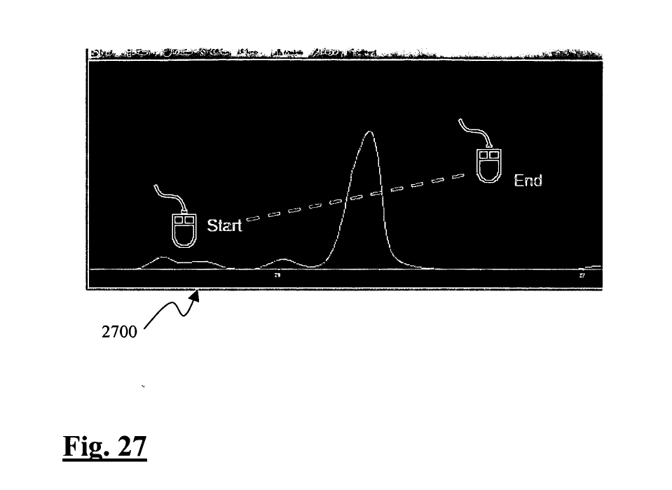

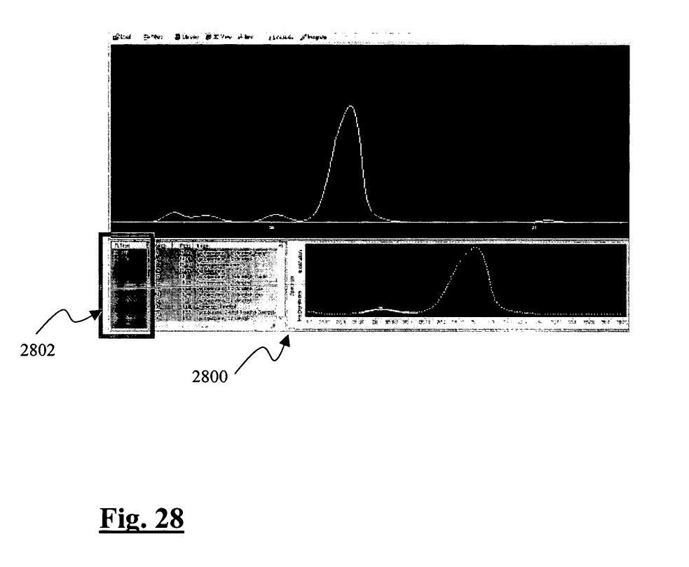

In performing analyses of MS and GC data, the user may wish to perform ion interference analysis. As shown in FIG. 26, to access this feature, the user selects “Analysis” from the toolbar 400. As shown in FIG. 27, the user then selects the time segment to be analyzed, for example, by clicking and dragging over the MS display, from the desired start time to the desired end time. The ions in the specified time segment are analyzed, and the retention times of the identified peaks are displayed, for example, in a list of retention times 2802, as shown in FIG. 28. In one implementation, an algorithm identifies ion interference caused by neighboring or co-eluting peaks, and reduces or removes the ion interference.

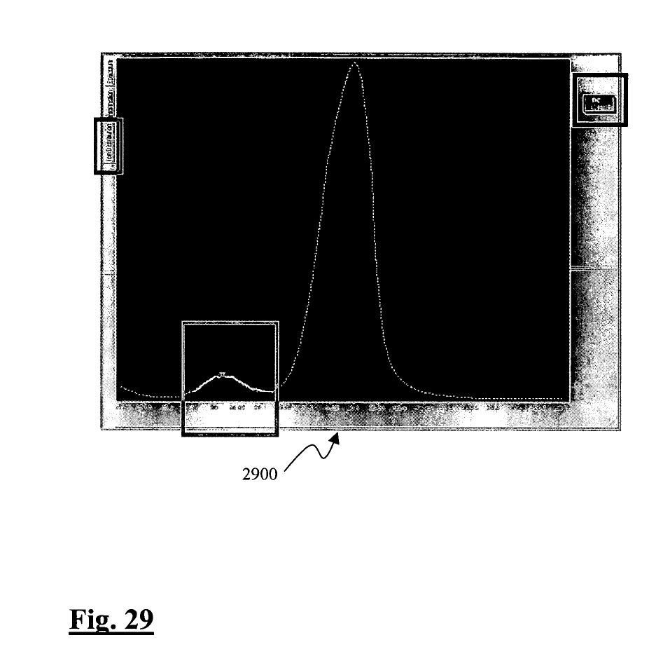

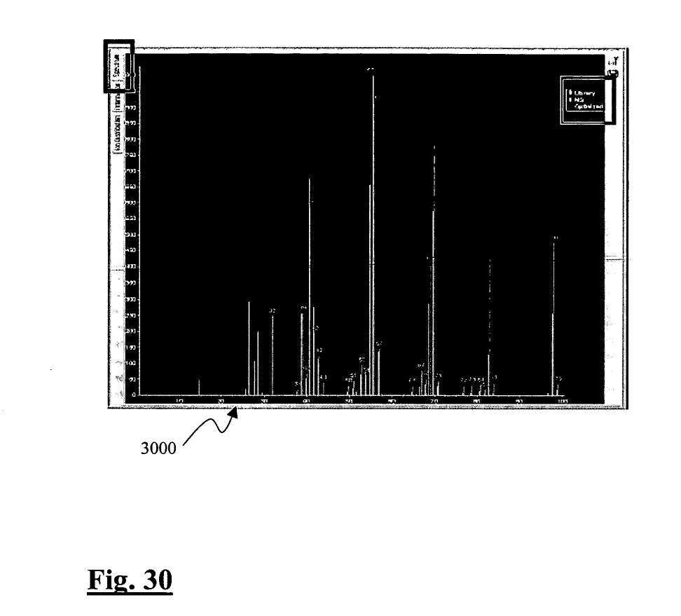

From the list of retention times 2802, the user may select a retention time to view more information about the interference-free peak. As shown in FIG. 29, an ion distribution panel 2900 shows the most probable location of the detected peak, based on the distribution of the most abundant mass. The user may view the spectrum panel 3000, shown in FIG. 30. The spectrum panel 3000 displays the extracted spectrum, the optimized spectrum, and the library spectrum. The library spectrum displayed is the library spectrum identified when the optimized spectrum is submitted to the matching engine.

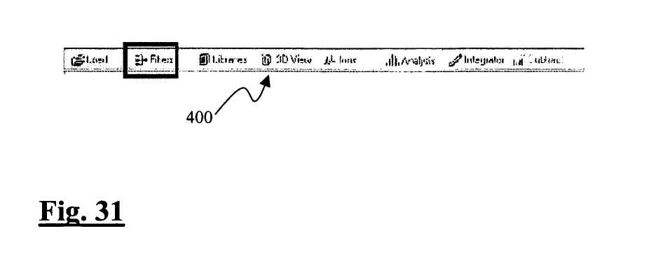

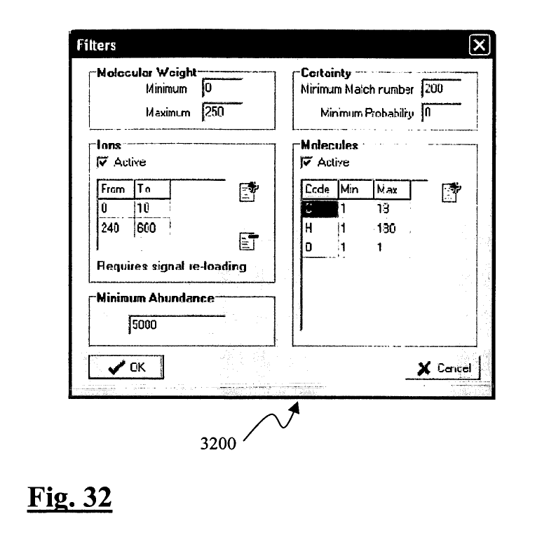

In performing analyses of MS and GC data, the user may wish to filter the data presented. In one implementation, the present invention provides a Search Engine Filter, an Extracted Ion Filter, and an Extracted Spectrum Filter. As shown in FIG. 31, to access these filters, the user selects “Filter” from the toolbar 400, and the GUI screen 3200 of FIG. 32 is presented.

The Search Engine Filter is used to narrow down the list of matching spectra returned by the search engine. In one implementation, the only criterion used by the search engine during spectrum matching is the ion distribution pattern. Therefore, the resulting list can include components that are out of the scope of the analysis. The filters provided by the present invention allow the user to remove undesirable components.

As shown in FIG. 32, the Search Engine Filter includes a molecular weight filter, a molecule filter, and a certainty filter. To use the molecular weight filter, the user selects a range of molecular weights, and only components with molecular weight within the specified range will be displayed. In the example shown in FIG. 32, only components with molecular weight less than 250 will be allowed in the results.

Furthermore, the Search Engine Filter includes a molecule filter. The user specifies one or more molecules and/or a number of molecules. Only components that include the selected molecules and that have the number of molecules within the specified range will be allowed in the results. To add a new criterion for the molecule filter, the user selects the “plus” button within the section.

In addition, the Search Engine Filter includes a certainty filter. The user specifies a matching number and a probability, and the filter removes any component with a resulting match number and probability number lower than the specified threshold. In the example shown in FIG. 32, while the probability number is ignore, any component with a matching number less than 200 will be rejected.

The Extracted Ion filter is used to exclude selected ions from the total ion chromatogram. In one implementation, this filter is applied when the MS data is loaded. It is used, for example, to remove noise or to reduce the amount of information loaded in memory. In the example shown in FIG. 32, the total ion chromatogram will be loaded without ions less than 11, and without ions between 240 and 600.

The Extracted Spectrum Filter, also known as the abundance filter, removes any mass with an abundance less than the specified threshold from the MS file data. In one implementation, the masses are filtered before the spectrum is submitted to the search engine. In the example shown in FIG. 32, any mass with abundance less than 5000 will be removed from the MS file data.

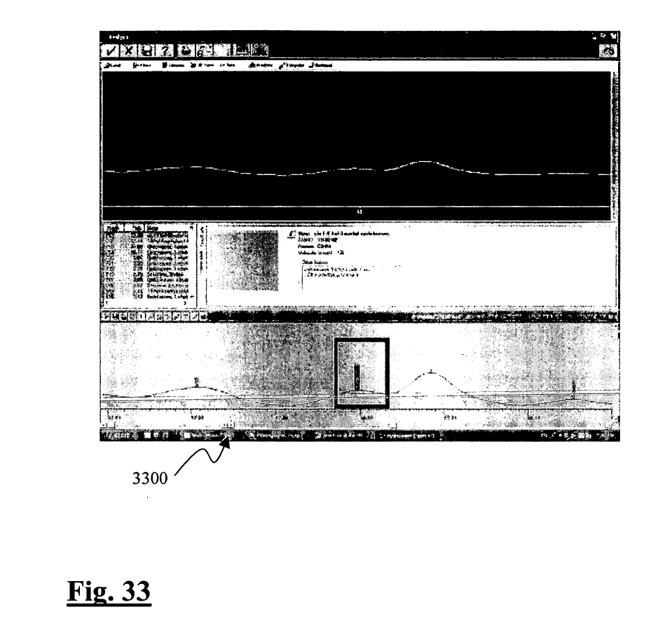

In using the present invention, the user may wish to transfer MS data to the active parameter data file. The active parameter data file, also know as the HCD, is the file being used in the identification of the sample being analyzed. All the identification data are kept in this file. As shown in FIG. 33, to transfer MS data to the active parameter data file, the user selects the corresponding peak from the GC display. The selected peak is frequently an unknown component. The user selects a name for the component.

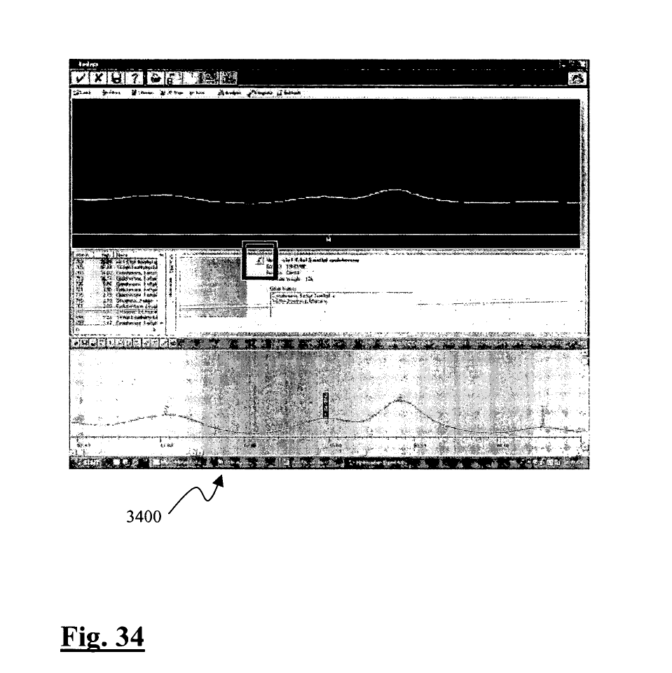

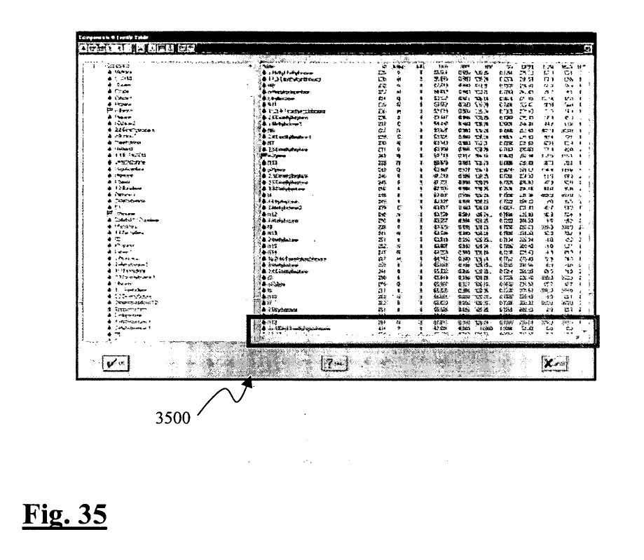

As shown in FIG. 34, the user selects the “Transfer” button to insert the new component. The new component is inserted in the active parameter data file based upon the retention time. As shown in FIG. 35, the user enters any known physical properties of the component.

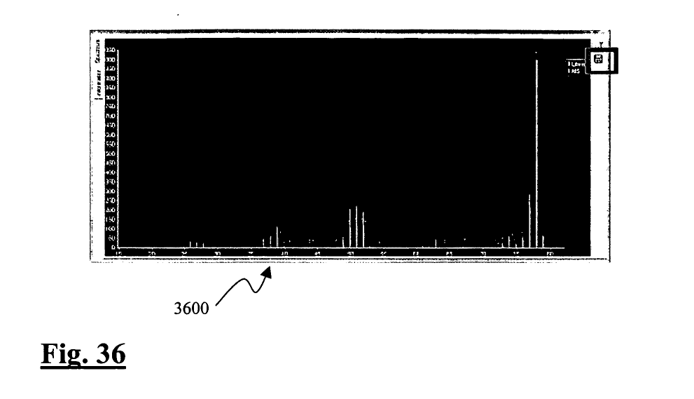

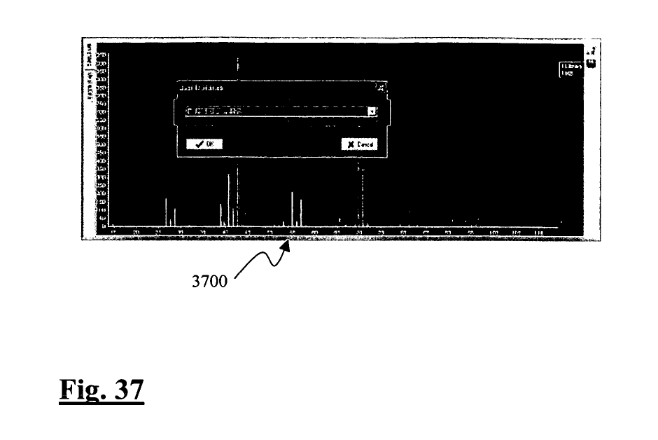

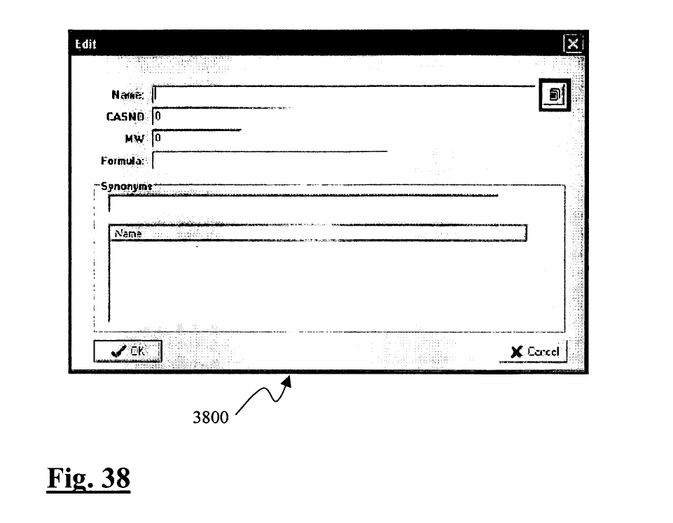

In using the present invention, the user may wish to transfer experimentally determined spectral data to the libraries. As shown in FIG. 36, the user selects the floppy disk icon. As shown in FIG. 37, the user then selects the library where the new spectrum will be stored. As shown in FIG. 38, the user then enters information, for example, into a dialog box. If the new spectrum is to be added to an existing component, the user selects the Book button. A list of all the components in the database is displayed to the user, and the user selects the appropriate component to correlate the spectrum to the component.

Example embodiments of the present invention have now been described in accordance with the above advantages. It will be appreciated that these examples are merely illustrative of the invention. Many variations and modifications will be apparent to those skilled in the art.

What is claimed is:

1. A method for displaying data to a user, comprising:
receiving gas chromatography data, the gas chromatography data including at least one elution peak;
receiving mass spectrometry data, the mass spectrometry data including at least one mass spectrum;
correlating the gas chromatography data and the mass spectrometry data; and
displaying the gas chromatography data and the mass spectrometry data to a user.

2. The method of claim 1, wherein correlating the gas chromatography data and the mass spectrometry data comprises:
correlating at least one elution peak of the gas spectrometry data with at least one mass spectrum from the mass spectrometry data.

3. The method of claim 1, wherein correlating the gas chromatography data and the mass spectrometry data comprises:
representing the mass spectrometry data in the time domain.

4. The method of claim 1, wherein the gas chromatography data are received from a gas chromatography detector.

5. The method of claim 1, wherein the mass spectrometry data are received from a mass spectrometer.

6. The method of claim 1, further comprising:
identifying an extracted mass spectrum, the extracted mass spectrum being included in the mass spectrometry data.

7. The method of claim 6, wherein identifying the extracted mass spectrum comprises:
receiving a selection from a user.

8. The method of claim 6, further comprising:
displaying the extracted mass spectrum to the user.

9. The method of claim 6, further comprising:
searching at least one library to identify one or more components, each of the identified components having a mass spectrum matching the extracted mass spectrum.

10. The method of claim 9, further comprising:
displaying the name of at least one of the identified components to the user.

11. The method of claim 9, further comprising:
displaying the mass spectrum of at least one of the identified components to the user.

12. The method of claim 9, further comprising:
transferring data from the at least one library to an active parameter data file.

13. The method of claim 1, further comprising:
identifying at least one library, each identified library containing at least one component, each component having at least one mass spectrum.

14. The method of claim 12, wherein identifying at least one library comprises:
receiving a selection from a user.

15. The method of claim 12, further comprising:
identifying a mass spectrum, the extracted mass spectrum being included in the mass spectrometry data.

16. The method of claim 14, further comprising:
searching the identified libraries to identify one or more components, each of the identified components having a mass spectrum matching the identified mass spectrum.

17. The method of claim 15, further comprising:
displaying the name of at least one of the identified components to the user.

18. The method of claim 15, further comprising:
displaying the mass spectrum of at least one of the identified components to the user.

19. The method of claim 9, further comprising:
transferring data for at least one of the identified components from the at least one library to an active parameter data file.

20. A system for displaying data to a user, comprising:
means for receiving gas chromatography data, the gas chromatography data including at least one elution peak;
means for receiving mass spectrometry data, the mass spectrometry data including at least one mass spectrum;
means for correlating the gas chromatography data and the mass spectrometry data; and
means for displaying the gas chromatography data and the mass spectrometry data to a user.

21. A system for displaying data to a user, comprising:
a processor;
a repository accessible by the processor; and
a display device for displaying information received from the processor,
wherein gas chromatography data including at least one elution peak is received and stored in the repository;
wherein mass spectrometry data including at least one mass spectrum is received and stored in the repository;
wherein the gas chromatography data and the mass spectrometry data are correlated via the processor; and
wherein the gas chromatography data and the mass spectrometry data are displayed via the display device.

22. The system of claim 19, wherein the processor is housed on a terminal.

23. The system of claim 20, wherein the terminal is selected from a group consisting of a personal computer, a minicomputer, a main frame computer, a microcomputer, a hand held device, a telephonic device, a gas chromatography detector, a mass spectrometer, and a gas chromatography detector/mass spectrometer.

24. The system of claim 19, wherein the processor is housed on a server.

25. The system of claim 22, wherein the server is selected from a group consisting of a personal computer, a minicomputer, a microcomputer, and a main frame computer.

26. The system of claim 22, wherein the server is coupled to a network.

27. The system of claim 24, wherein the input is received via the network.

28. The system of claim 24, wherein the network is the Internet.

29. The system of claim 24, wherein the server is coupled to the network via a coupling.

30. The system of claim 27, wherein the coupling is selected from a group consisting of a wired connection, a wireless connection, and a fiberoptic connection.

31. The system of claim 19, wherein the repository is housed on a server.

32. The system of claim 29, wherein the server is coupled to a network.

33. A computer program product comprising a computer usable medium having control logic stored therein for causing a computer to provide interactive assistance with performing a transaction between a financial institution and an end user, the control logic comprising:
first computer readable program code means for receiving gas chromatography data, the gas chromatography data including at least one elution peak;
second computer readable program code means for receiving mass spectrometry data, the mass spectrometry data including at least one mass spectrum;
third computer readable program code means for correlating the gas chromatography data and the mass spectrometry data; and
fourth computer readable program code means for displaying the gas chromatography data and the mass spectrometry data to a user.
